(19) United States
(12) Patent Application Publication
(10) Pub. No.: US 2006/0030493 A1
(43) Pub. Date: Feb. 9, 2006

(54) Crosslinked treatment fluid compositions and methods

(76) Inventor: Michael J.R. Segura, Duncan, OK (US)

Correspondence Address: Robert A. Kent;Halliburton Energy Services, 2600 S. 2nd Street, Duncan, OK, 73536-0440, US

(21) Appl. No.: 10/909,988

(22) Filed: Aug. 3, 2004

(51) Int. Cl. C09K 8/58; E21B 43/00

(52) U.S. Cl. 507/244

(57) ABSTRACT

Method of treating a subterranean formation with a treatment fluid comprising providing water; providing a carbonyl-containing first compound comprising at least one carbonyl moiety; providing an amine-containing second compound comprising at least one amine moiety; combining the water, carbonyl-containing first compound, and amine-containing second compound to a substantially uniform mixture; allowing at least one crosslink to form between at least one carbonyl moiety and at least one amine-moiety to form a crosslinked treatment fluid; and, placing the crosslinked treatment fluid into the subterranean formation. Also, a subterranean treatment fluid comprising water, a carbonyl-containing first compound comprising at least one carbonyl moiety, and an amine-containing second compound comprising at least one amine moiety wherein at least one crosslink is formed between at least one carbonyl moiety and at least one amine moiety and wherein the treatment fluid is suitable for use in a subterranean treatment operation.

### BACKGROUND

The present invention relates to treatment fluid compositions having novel gelling agents and methods of making and using such treatment fluids in subterranean applications.

A subterranean treatment fluid may be used in a subterranean formation in a variety of ways. For example, a treatment fluid may be used to drill a borehole in a subterranean formation, to stimulate a well bore in a subterranean formation, or to clean up a well bore in a subterranean formation, as well as for numerous other purposes. As used herein, “treatment fluid” refers to any fluid that may be used in a subterranean application in conjunction with a desired function and/or for a desired purpose. The term “treatment fluid” does not imply any particular action by the fluid. Oftentimes treatment fluids used in subterranean applications are viscosified. While viscosifying fluids may serve many purposes, one purpose is to increase the ability of a fluid to transports solid particulates such as proppant or gravel. Treatment fluids generally have a viscosity that is sufficiently high to suspend particulates for a desired period of time, to transfer hydraulic pressure, and/or to prevent undesired leak-off of fluids into the formation.

Viscosified treatment fluids that are used in subterranean operations generally are aqueous-based fluids that comprise a gelling agent. These gelling agents may comprise biopolymers or synthetic polymers. Some common gelling agents include, e.g., galactomannan gums, cellulose derivatives, and other polysaccharides.

The viscosity of a viscosified treatment fluid containing a gelling agent] may be increased by crosslinking at least some of the gelling agent molecules with a crosslinking agent that may be added to the treatment fluid. Typical crosslinking agents generally comprise a metal, transition metal, or metalloid, collectively referred to herein as “metal(s).” Examples include boron, aluminum, antimony, zirconium, magnesium, or titanium. Under the appropriate conditions (e.g., pH and temperature), the crosslinks that form between gelling agent molecules may increase the viscosity of a treatment fluid.

The chemical nature of the crosslink in part determines the stability and rheological properties of the treatment fluid and, in part, the applications to which the treatment fluid may be put. For example, boron crosslinking agents are frequently used in treatment fluids and are compatible with a number of gelling agents. But, boron crosslinking agents are typically limited to use in environments that have a pH of about 8 and above. This pH requirement may be problematic because, inter alia, it may preclude the use of seawater in the treatment fluid or the use of the treatment fluid in an offshore environment. Similarly, treatment fluids comprising gelling agents that are crosslinked with boron may suffer from thermal instability at certain elevated temperatures like those frequently encountered in some subterranean operations. In addition, boron crosslinking agents often react with additives commonly added to treatment fluids, e.g., glycols (such as ethylene or propylene glycol) or alcohols (such as methanol). To overcome this propensity, boron crosslinking agents are typically added in excess to treatment fluids, which may increase the environmental footprint and the costs associated with the treatment fluid.

Crosslinking agents that use metals other than boron, such as zirconium and titanium, are also frequently used in treatment fluids. These crosslinking agents generally form crosslinks that are more stable than those formed by boron crosslinking agents. Although treatment fluids that are crosslinked with non-boron crosslinking agents are more stable, they may be more difficult to break thus making recovery of the fluid from the well bore more difficult.

### SUMMARY

The present invention relates to treatment fluid compositions having novel gelling agents and methods of making and using such treatment fluids in subterranean applications.

One embodiment of the present invention provides a method of treating a subterranean formation with a treatment fluid comprising providing water; providing a carbonyl-containing first compound comprising at least one carbonyl moiety; providing an amine-containing second compound comprising at least one amine moiety; combining the water, carbonyl-containing first compound, and amine-containing second compound to a substantially uniform mixture; allowing at least one crosslink to form between at least one carbonyl moiety and at least one amine-moiety to form a crosslinked treatment fluid; and, placing the crosslinked treatment fluid into the subterranean formation.

Another embodiment of the present invention provides a method of fracturing a subterranean formation comprising providing water; providing a carbonyl-containing first compound comprising at least one carbonyl moiety; providing an amine-containing second compound comprising at least one amine moiety; combining the water, carbonyl-containing first compound, and amine-containing second compound to a substantially uniform mixture; allowing at least one crosslink to form between at least one carbonyl moiety and at least one amine-moiety to form a crosslinked fracturing fluid; and, placing the fracturing fluid in the subterranean formation at a pressure sufficient to create or enhance one or more fractures therein.

Another embodiment of the present invention provides a method of placing a gravel pack in a subterranean formation comprising providing gravel; providing water; providing a carbonyl-containing first compound comprising at least one carbonyl moiety; providing an amine-containing second compound comprising at least one amine moiety; combining the water, carbonyl-containing first compound, and amine-containing second compound to a substantially uniform mixture; allowing at least one crosslink to form between at least one carbonyl moiety and at least one amine-moiety to form a crosslinked gravel packing fluid; and, placing the crosslinked gravel packing fluid and gravel in a portion of a well bore so as to create a gravel pack.

Another embodiment of the present invention provides a subterranean treatment fluid comprising water, a carbonyl-containing first compound comprising at least one carbonyl moiety, and an amine-containing second compound comprising at least one amine moiety wherein at least one crosslink is formed between at least one carbonyl moiety and at least one amine moiety and wherein the treatment fluid is suitable for use in a subterranean treatment operation.

The features and advantages of the present invention will be readily apparent to those skilled in the art upon a reading of the description of the embodiments that follows.

### DETAILED DESCRIPTION

The present invention relates to treatment fluid compositions having novel gelling agents and methods of making and using such treatment fluids in subterranean applications.

The treatment fluids of the present invention generally comprise water, a carbonyl-containing first compound comprising at least one carbonyl moiety, and an amine-containing second compound comprising at least one amine moiety. As used herein, the term “moiety” refers to a specific segment or functional group of a chemical molecule. In some embodiments of the present invention the first compound is a gelling agent comprising at least one carbonyl moiety and the second compound is a crosslinking agent containing at least one amine moiety. In other embodiments, the first compound is a crosslinking agent containing at least one carbonyl moiety and the second compound is a gelling agent comprising at least one amine moiety. When combined, the carbonyl-containing first compound and amine-containing second compound are capable of forming at least one crosslink between a carbonyl moiety and an amine moiety. Crosslinked fluids formed from the carbonyl-containing first compound and amine-containing second compound generally provide favorable breaks as compared to traditional crosslinked fluids such as fluids crosslinked with titanium or zirconium. Moreover, the crosslinks formed between a carbonyl-containing first compound and an amine-containing second compound of the present invention may be reversed by changing the pH of the fluid in a manner similar to boron crosslinked gels. The crosslinks formed in the fluids of the present invention are generally stable from slightly acidic (pH of about 4) up to somewhat basic (pH of about 11). Such pH-sensitive crosslinks are known to provide favorable breaks.

The water of the treatment fluids of the present invention may comprise fresh water, salt water (e.g., water containing one or more salts dissolved therein), brine (e.g., saturated salt water), or seawater. The water can be from any source so long as it does not contain an excess of compounds that might adversely affect other components in the treatment fluid.

Gelling agents suitable for use as either a carbonyl-containing first compound or an amine-containing second compound in the present invention typically comprise a biopolymer, a synthetic polymer, or a combination thereof. A variety of gelling agents can be used in conjunction with the methods and compositions of the present invention, including, but not limited to, hydratable polymers that contain one or more functional groups such as hydroxyl, trans-hydroxyl, cis-hydroxyl, carboxylic acids, derivatives of carboxylic acids, sulfate, sulfonate, phosphate, phosphonate, amino, or amide. In certain exemplary embodiments, the gelling agents may be biopolymers comprising polysaccharides, and derivatives thereof that contain one or more of the following monosaccharide units: galactose, mannose, glucose, xylose, arabinose, fructose, glucuronic acid, or pyranosyl sulfate. Examples of suitable biopolymers include, but are not limited to, guar gum and derivatives thereof, such as hydroxypropyl guar and carboxymethylhydroxypropyl guar, and cellulose derivatives, such as hydroxyethyl cellulose, and bacterial polysaccharides such as xanthan. Additionally, synthetic polymers and copolymers that contain the above-mentioned functional groups may be used. Examples of such synthetic polymers include, but are not limited to, polyacrylate, polymethacrylate, polyacrylamide, polyvinyl alcohol, and polyvinylpyrrolidone. In other exemplary embodiments, the gelling agent molecule may be depolymerized. The term “depolymerized,” as used herein, generally refers to a decrease in the molecular weight of the gelling agent molecule. Depolymerized gelling agent molecules are described in U.S. Pat. No. 6,488,091 issued Dec. 3, 2002 to Weaver, et al., the relevant disclosure of which is incorporated herein by reference. Suitable gelling agents generally are present in the treatment fluids of the present invention in an amount in the range of from about 0.1% to about 5% by weight of the water therein. In certain exemplary embodiments, the gelling agents are present in a treatment fluid of the present invention in an amount in the range of from about 0.2% to about 1% by weight of the water therein.

A crosslinking agent is a compound that may be used to create a chemical link with the molecules of another material. The chemical link created by the agent may be temporary, reversible, or permanent. While crosslinking agents are often modeled as relatively small, discreet molecules such as borates, titanates, and zirconates, they may also be polymeric. Generally, the properties described above as to gelling agents (that they may be a biopolymer, a synthetic polymer, or a combination thereof, that they may contain varied functional moieties) apply equally well to compounds suitable for use as crosslinking agents in the present invention.

The carbonyl-containing first compound, whether it is a gelling agent or a crosslinking agent, must contain a carbonyl moiety capable of forming a crosslink with an amine-containing moiety. Suitable carbonyl moieties include, but are not limited to, ketone moieties and aldehyde moieties. In certain embodiments, the first compound may be oxidized to form a carbonyl group. Suitable oxidizers include, but are not limited to, periodic acid, periodates (IO₄⁻), and salts thereof (e.g., potassium periodoate). In some embodiments wherein the compound being modified to have a carbonyl moiety is a polysaccharide gelling agent, the amount of oxidizer used ranges from about 0.1 mol % to about 25 mol % of oxidizing agent relative to the mole equivalents of anhydro-sugar units making up the polysaccharide; in other embodiments the amount of oxidizer ranges from about 0.5 mol % to about 15 mol %; and in still other embodiments the amount of oxidizer ranges from about 1 mol % to about 10 mol %. The degree of oxidation will depend on the desired gel strength, crosslink time, and any potential loss of base fluid viscosity due to oxidation, all of which will be understood by those practiced in the art. In certain exemplary embodiments, the first compound may be oxidized or otherwise modified to contain a carbonyl moiety before its inclusion in a treatment fluid. In other embodiments, the first compound may be oxidized or otherwise modified to contain a carbonyl moiety on-the-fly, generally after incorporation into a treatment fluid. In some such embodiments, an oxidizing agent capable of interacting with the first compound to form a carbonyl-containing first compound is added to a treatment fluid and the first compound is then modified in situ in the treatment fluid to comprise a carbonyl moiety. It will be understood by one skilled in the art that to create carbonyl-containing first compounds suitable for use in the present invention, methods other than oxidation, such as derivatization of the compound with a carbonyl containing chemical compound, may be suitable for adding a carbonyl group to a suitable gelling agent to create a carbonyl gelling agent. The number of carbonyl groups present on the first compound may be tailored to achieve certain crosslinking properties. For example, where a greater number of crosslinks are desired, the first compound may be modified such that it contains a greater number of carbonyl moieties.

The amine-containing second compound, whether it is a gelling agent or a crosslinking agent, must contain an amine moiety capable of forming a crosslink with a carbonyl -containing moiety. The amine moiety of the second compound is itself capable of forming an imine functional group or an enamine functional group. Suitable amine groups include primary amines and secondary amines. Suitable amine-containing moieties include, but are not limited to, a hydrazide group (i.e., NH₂—NH—CO—), a hydrazine group (i.e., —NH—NH₂); diamino compounds such as ethylenediamine, diaminohexane, or amino acids; polyethyleneimine; polyallylamine; proteins and peptides; or a combination thereof. In some embodiments of the methods of the present invention, the amine-containing second compound may be a polymer. The number of amine groups present on an amine-containing second compound may be tailored to achieve certain crosslinking properties. For example, where a greater number of crosslinks are desired, the amine-containing second compound may be modified such that it contains a greater number of amine moieties.

The carbonyl-containing first compounds and amine-containing second compounds suitable for use in the treatment fluids of the present invention are capable of interacting to form one or more crosslinks. Generally, such crosslinks may be formed when a carbonyl moiety from carbonyl-containing first compound reacts with an amine moiety from an amine-containing second compound. The reaction may form a carbinolamine, an imine, an enamine, or a combination thereof. The stability of any resultant imine or enamine may be dependent on pH, temperature, or both. An imine may be formed under mildly acid conditions of from about pH 3 to about pH 10 and mild temperatures of from about 10° C. to about 75° C. When the carbonyl moiety and amine moiety react, a crosslink is formed.

While an imine or enamine group may be useful in forming the crosslink, in certain embodiments, once the crosslink is formed it may be made more stable by reducing the imine or enamine to an amine, e.g., via reductive amination. Such a reduction reaction works to make the crosslink substantially less reversible. A reduction may be accomplished with any suitable reducing agent. Suitable readily available reducing agents include, but are not limited to, borohydrides and cyanoborohydrides. In certain exemplary embodiments, the reducing agent is sodium borohydride (NaBH₄). At least in part, selection of a reducing agent depends on the desired strength of the reducing agent desired; for example, under certain conditions borohydrides will reduce both the imine and carbonyl groups whereas the cyanoborohydrides will only reduce the imine groups. Persons having ordinary skill in the art, with the benefit of this disclosure, will recognize the appropriate reducing agent to use depending on, e.g., the specific gelling agent used, the specific crosslinking agent used, and the like.

In certain embodiments, an imine may allow for a reversible crosslink, thereby providing a simple means to reduce the viscosity of the treatment fluid. For example, adjusting the pH and/or temperature so as to destabilize the imine and break the crosslink may reduce the viscosity of the treatment fluid. In other embodiments, the reversible crosslink may provide a means to recycle or reuse the treatment fluid or a component thereof.

Reducing the viscosity of a treatment fluid also may occur by breaking the treatment fluid. The treatment fluids of the present invention also may comprise breakers such as bases, acids, oxidizers, and enzymes. Suitable breakers include enzymes, oxidizers, bases, and acids. In certain embodiments, the action of a breaker may be delayed for a desired period. Examples of such delayed breakers include, but are not limited to, various lactones, esters, encapsulated acids and slowly soluble acid generating compounds, oxidizers which produce acids upon reaction with water, water reactive metals such as aluminum, lithium and magnesium, and the like. Alternatively, any of the delayed breakers conventionally used with metal crosslinking agents may be used, for example, oxidizers such as sodium chlorite, sodium bromate, sodium persulfate, ammonium persulfate, encapsulated sodium persulfate, potassium persulfate, or ammonium persulfate and the like as well as magnesium peroxide. Enzyme breakers that may be employed include, but are not limited to, alpha and beta amylases, amyloglucosidase, invertase, maltase, cellulase, and hemicellulase, combinations thereof, and the like. The specific breaker used, whether or not it is encapsulated, and the amount thereof employed, will depend upon the breaking time desired, the nature of the gelling agent and crosslinking agent, formation characteristics and conditions, and other factors known, with the benefit of this disclosure, to individuals skilled in the art.

The treatment fluids of the present invention optionally may further comprise particulates suitable for subterranean applications. Suitable particulates include, for example, gravel, natural sand, quartz sand, particulate garnet, glass, ground walnut hulls, nylon pellets, aluminum pellets, bauxite, ceramics, polymeric materials, plastic materials, a combination thereof, or the like. Suitable sizes range from about 4 to about 100 U.S. mesh. In certain exemplary embodiments, the particulates have a particle size in the range of from about 10 to about 70 U.S. mesh. In certain exemplary embodiments, the particulates used may be included in the treatment fluid to form a gravel pack down hole, as a proppant in fracturing operations, or as a bridging agent in a fluid loss control operation. In certain exemplary embodiments, the particulates used may be included in the treatment fluid to form a gravel pack down hole, as a proppant in fracturing operations, or as a bridging agent in a fluid loss control operation. In certain embodiments, the particulates may be at least partially coated with a resin, tackifying agent, or other consolidation material.

Additional additives may be present in the treatment fluids of the present invention as deemed appropriate by one skilled in the art with the benefit of this disclosure. Examples of such additives include, but are not limited to, acids, bases, buffers, surfactants, scale inhibitors, clay stabilizers, silicate-control agents, gases, antifoaming agents, flow assurance chemicals, foaming agents, storage stabilizers, biocides, biostatic agents, or combinations thereof. In addition, traditional crosslinking agents may be added to the treatment fluid in addition to the amine crosslinking agent of the present invention.

The treatment fluids of the present invention can be used for carrying out a variety of subterranean well treatments, including, but not limited to, fracturing, gravel packing, frac-packing, and plugging. In certain exemplary embodiments wherein a treatment fluid is used in conjunction with fracturing operations, fracturing fluids comprising water, a carbonyl-containing first compound (which may be a gelling agent or a crosslinking agent), and an amine-containing second compound (which is a gelling agent where the carbonyl-containing first compound is a crosslinking agent, or vice versa) may be placed in a subterranean formation at a sufficient pressure to create or enhance one or more fractures therein. After the fracturing fluid has performed its desired function, or after a desired period of time, the viscosity of the fracturing fluid may be reduced and the fracturing fluid recovered.

In certain exemplary embodiments wherein the treatment fluids of the present invention are used in conjunction with gravel packing operations, gravel packing fluids comprising water, a particulate, a carbonyl-containing first compound (which may be a gelling agent or a crosslinking agent), and an amine-containing second compound (which is a gelling agent where the carbonyl-containing first compound is a crosslinking agent, or vice versa) are placed in a portion of a well bore so as to create a gravel pack. After the gravel pack is substantially in place, the viscosity of the gravel packing fluid may be reduced and the gravel packing fluid recovered.

To facilitate a better understanding of the present invention, the following examples are given. In no way should the following examples be read to limit or define the scope of the invention.

### EXAMPLE 1

For this example, a 0.48 wt % solution of guar galactomannan was oxidized with 0.0068% of potassium periodate (by weight of water) at room temperature for at least 30 min to afford an oxidized guar with a molar substitution of 1 mol % (MS 0.01) relative to moles of anhydro-sugar units. Varying amounts of a polyethyleneimine (M_{w} 25 K) (PEI) solution were added to form samples with final PEI concentrations ranging from 0.003% to 0.06% (by weight of water). After mixing in the PEI material, samples were left to sit for at least 30 min prior to measurement. For comparison, another 0.48% solution of ordinary guar was crosslinked with borax (4.9 mM boron) at pH 10 and measured for comparison. In the figure legends, this sample is referred to as “borate.”

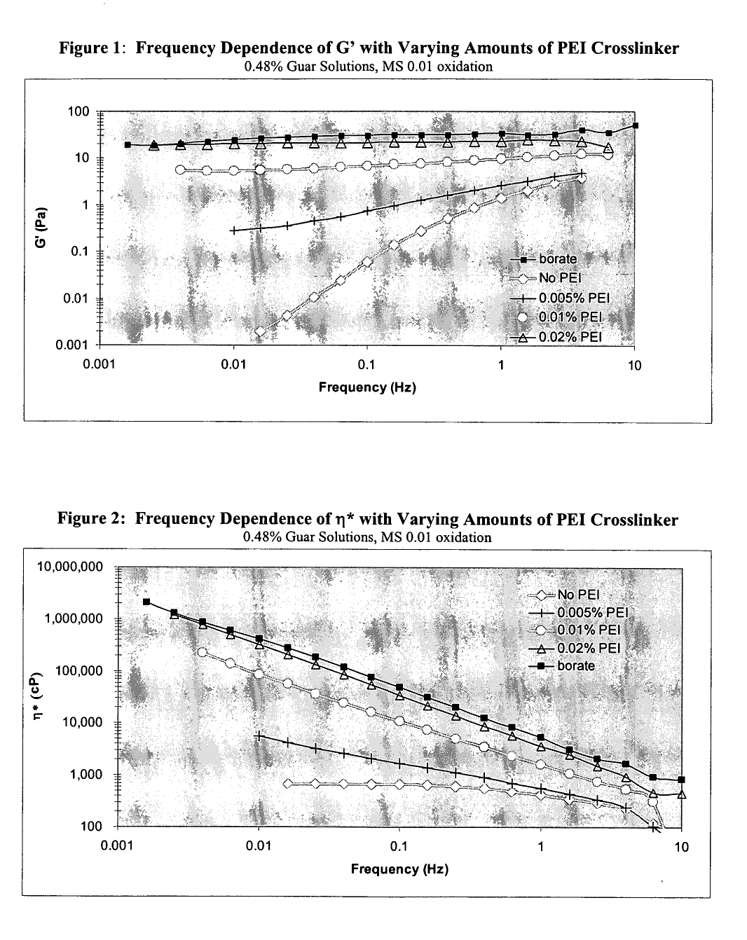

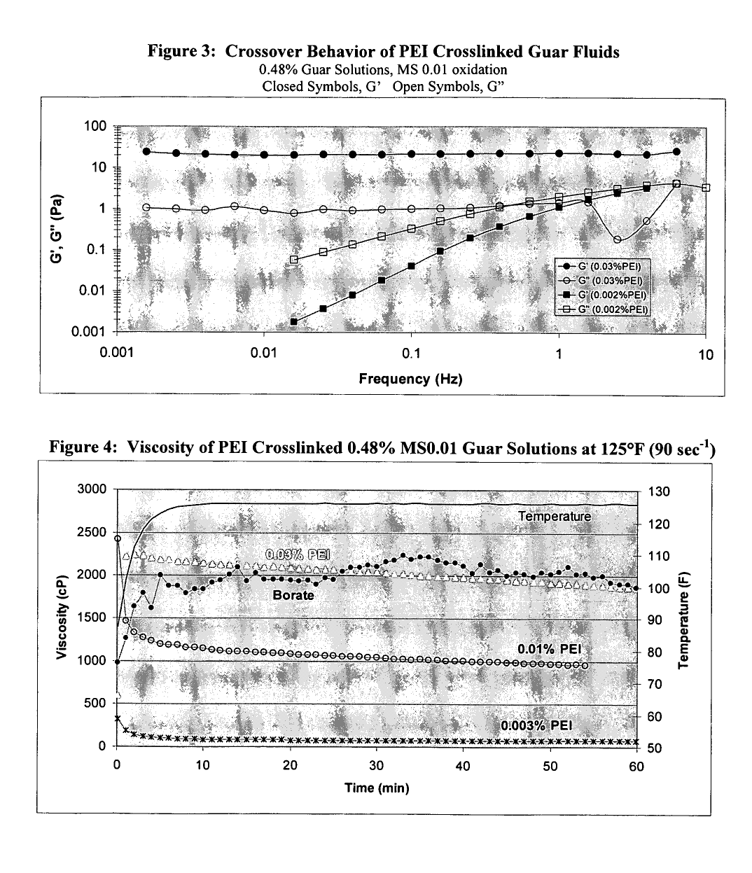

Oscillatory rheology measurements were made with a Haake RS150 rheometer at 73° F. (23° C.) using a 60 mm, 2° cone with a gap width of 0.106 mm. The applied stress was held constant at 1 Pa and frequency ramped from 10 Hz to 0.001 Hz for determination of the storage modulus (G′), loss modulus (G″), and the complex viscosity (η*). The G′, G″, and η* measurements are shown in FIGS. 1 through 3. FIG. 1 shows the increase in G′ (a measure of the elasticity of the fluid) as more PEI crosslinker is added. Similarly, FIG. 2 shows how the complex viscosity of the fluid increases as PEI crosslinker is added. A common definition of a gel, known to those skilled in the art, is that G′ is greater than G″ over all reasonable frequencies. This is demonstrated in FIG. 3 which shows that at low PEI concentrations, the relationship is G″>G′for most frequencies. However, as the amount of PEI crosslinker is increased and a gel is formed, the relationship becomes G′>G″ over all frequencies.

In a similar manner, 0.48% solutions of oxidized guar (MS0.01) were crosslinked with PEI where the final PEI concentrations ranged from 0.003% to 0.03% (by weight of water). Samples were allowed to mix and react for a minimum of 30 min. and then their steady shear viscosities were measured. Gel viscosities were measured on a Brookfiled PVS rheomenter using Couette geometry. All measurements were taken at a shear rate of 90 sec⁻¹ and 125° F. The results are shown in FIG. 4.

The above example demonstrates, inter alia, that the methods of the present invention are useful for preparing treatment fluids for use in subterranean applications.

Therefore, the present invention is well adapted to carry out the objects and attain the ends and advantages mentioned as well as those that are inherent therein. While numerous changes may be made by those skilled in the art, such changes are encompassed within the spirit and scope of this invention as defined by the appended claims.

What is claimed is:

1. A method of treating a subterranean formation with a treatment fluid comprising:
providing water;
providing a carbonyl-containing first compound comprising at least one carbonyl moiety;
providing an amine-containing second compound comprising at least one amine moiety;
combining the water, carbonyl-containing first compound, and amine-containing second compound to a substantially uniform mixture;
allowing at least one crosslink to form between at least one carbonyl moiety and at least one amine-moiety to form a crosslinked treatment fluid; and,
placing the crosslinked treatment fluid into the subterranean formation.

2. The method of claim 1 wherein the carbonyl-containing first compound is a gelling agent and the amine-containing second compound is a crosslinking agent.

3. The method of claim 1 wherein the carbonyl-containing first compound is a crosslinking agent and the amine-containing second compound is a gelling agent.

4. The method of claim 1 wherein the carbonyl moiety comprises a ketone moiety, or an aldehyde moiety.

5. The method of claim 1 wherein the carbonyl-containing first compound comprises a conventional gelling agent and a carbonyl moiety.

6. The method of claim 5 wherein the conventional gelling agent comprises a biopolymer, a synthetic polymer, or a combination thereof.

7. The method of claim 5 wherein the conventional gelling agent comprises a hydratable polymer that comprises one or more functional groups.

8. The method of claim 5 wherein the conventional gelling agent comprises a polysaccharide.

9. The method of claim 8 wherein the polysaccharide comprises one or more of galactose, mannose, glucose, xylose, arabinose, fructose, glucuronic acid, or pyranosyl sulfate.

10. The method of claim 5 wherein the conventional gelling agent comprises a guar gum or a guar gum derivative.

11. The method of claim 5 wherein the conventional gelling agent comprises polyacrylate, polymethacrylate, polyacrylamide, polyvinyl alcohol, or polyvinylpyrrolidone.

12. The method of claim 5 wherein the conventional gelling agent comprises a substanially depolymerized gelling agent.

13. The method of claim 1 wherein the treatment fluid comprises a gelling agent in the range of from about 01.% to about 5% by weight of the water therein.

14. The method of claim 1 wherein the amine moiety comprises a hydrazide group, a hydrazine group; diamino compound; a polyhyleneimine; a polyallylamine; a protein; or a peptide.

15. The method of claim 1 further comprising, after the step of allowing at least one crosslink to from between at least one carbonyl moiety and at least one amine moiety, the step of contacting the crosslink with a reducing agent.

16. The method of claim 15 wherein the reducing agent comprises a borohydrides, a cyanoborohydrided, or a combination thereof.

17. A method of fracturing a subterranean formation comprising:
providing water;
providing a carbonyl-containing first compound comprising at least one carbonyl moiety;
providing an amine-containing second compound comprising at least one amine moiety;
combining the water, carbonyl-containing first compound, and amine-containing second compound to a substantially uniform mixture;
allowing at least one crosslink to form between at least one carbonyl moiety and at least one amine-moiety to form a crosslinked fracturing fluid; and,
placing the fracturing fluid in the subterranean formation at a pressure sufficient to create or enhance one or more fractures therein.

18. The method of claim 17 wherein the carbonyl-containing first compound is a gelling agent and the amine-containing second compound is a crosslinking agent.

19. The method of claim 17 wherein the carbonyl-containing first compound is a crosslinking agent and the amine-containing second compound is a gelling agent.

20. The method of claim 17 wherein the carbonyl moiety comprises a ketone moiety, or an aldehyde moiety.

21. The method of claim 17 wherein the carbonyl-containing first compound comprises a conventional gelling agent and a carbonyl moiety.

22. The method of claim 21 wherein the conventional gelling agent comprises a biopolymer, a synthetic polymer, or a combination thereof.

23. The method of claim 21 wherein the conventional gelling agent comprises a hydratable polymer that comprises one or more functional groups.

24. The method of claim 21 wherein the conventional gelling agent comprises a polysaccharide.

25. The method of claim 24 wherein the polysaccharide comprises one or more of galactose, mannose, glucose, xylose, arabinose, fructose, glucuronic acid, or pyranosyl sulfate.

26. The method of claim 21 wherein the conventional gelling agent comprises a guar gum or a guar gum derivative.

27. The method of claim 21 wherein the conventional gelling agent comprises polyacrylate, polymethacrylate, polyacrylamide, polyvinyl alcohol, or polyvinylpyrrolidone.

28. The method of claim 21 wherein the conventional gelling agent comprises a substanially depolymerized gelling agent.

29. The method of claim 17 wherein the treatment fluid comprises a gelling agent in the range of from about 0.1% to about 5% by weight of the water therein.

30. The method of claim 17 wherein the amine moiety comprises a hydrazide group, a hydrazine group; diamino compound; a polyethyleneimine; a polyallylamine; a protein; or a peptide.

31. The method of claim 17 further comprising, after the step of allowing at least one crosslink to form between at least one carbonyl moiety and at least one amine moiety, the step of contacting the crosslink with a reducing agent.

32. The method of claim 31 wherein the reducing agent comprises a borohydrides, a cyanoborohydrides, or a combination thereof.

33. The method of claim 17 wherein the crosslinked fracturing fluid further comprises particulates.

34. A method of placing a gravel pack in a subterranean formation comprising:
providing gravel;
providing water;
providing a carbonyl-containing first compound comprising at least one carbonyl moiety;
providing an amine-containing second compound comprising at least one amine moiety;
combining the water, carbonyl-containing first compound, and amine-containing second compound to a substantially uniform mixture;
allowing at least one crosslink to form between at least one carbonyl moiety and at least one amine-moiety to form a crosslinked gravel packing fluid; and,
placing the crosslinked gravel packing fluid and gravel in a portion of a well bore so as to create a gravel pack.

35. The method of claim 34 wherein the carbonyl-containing first compound is a gelling agent and the amine-containing second compound is a crosslinking agent.

36. The method of claim 34 wherein the carbonyl-containing first compound is a crosslinking agent and the amine-containing second compound is a gelling agent.

37. The method of claim 34 wherein the carbonyl moiety comprises a ketone moiety, or an aldehyde moiety.

38. The method of claim 34 wherein the carbonyl-containing first compound comprises a conventional gelling agent and a carbonyl moiety.

39. The method of claim 38 wherein the conventional gelling agent comprises a biopolymer, a synthetic polymer, or a combination thereof.

40. The method of claim 38 wherein the conventional gelling agent comprises a hydratable polymer that comprises one or more functional groups.

41. The method of claim 38 wherein the conventional gelling agent comprises a polysaccharide.

42. The method of claim 41 wherein the polysaccharide comprises one or more of galactose, mannose, glucose, xylose, arabinose, fructose, glucuronic acid, or pyranosyl sulfate.

43. The method of claim 38 wherein the conventional gelling agent comprises a guar gum or a guar gum derivative.

44. The method of claim 38 wherein the conventional gelling agent comprises polyacrylate, polymethacrylate, polyacrylamide, polyvinyl alcohol, or polyvinylpyrrolidone.

45. The method of claim 38 wherein the conventional gelling agent comprises a substanially depolymerized gelling agent.

46. The method of claim 34 wherein the treatment fluid comprises a gelling agent in the range of from about 0.1% to about 5% by weight of the water therein.

47. The method of claim 34 wherein the amine moiety comprises a hydrazide group, a hydrazine group; diamino compound; a polyethyleneimine; a polyallylamine; a protein; or a peptide.

48. The method of claim 34 further comprising, after the step of allowing at least one crosslink to form between at least one carbonyl moiety and at least one amine moiety, the step of contacting the crosslink with a reducing agent.

49. The method of claim 48 wherein the reducing agent comprises a borohydrides, a cyanoborohydrides, or a combination thereof.

50. A subterranean treatment fluid comprising water, a carbonyl-containing first compound comprising at least one carbonyl moiety, and an amine-containing second compound comprising at least one amine moiety wherein at least one crosslink is formed between at least one carbonyl moiety and at least one amine moiety and wherein the treatment fluid is suitable for use in a subterranean treatment operation.

51. The subterranean treatment fluid of claim 50 wherein the carbonyl-containing first compound is a gelling agent and the amine-containing second compound is a crosslinking agent.

52. The subterranean treatment fluid of claim 50 wherein the carbonyl-containing first compound is a crosslinking agent and the amine-containing second compound is a gelling agent.

53. The subterranean treatment fluid of claim 50 wherein the carbonyl moiety comprises a ketone moiety, or an aldehyde moiety.

54. The subterranean treatment fluid of claim 50 wherein the carbonyl-containing first compound comprises a conventional gelling agent and a carbonyl moiety.

55. The subterranean treatment fluid of claim 54 wherein the conventional gelling agent comprises a biopolymer, a synthetic polymer, or a combination thereof.

56. The subterranean treatment fluid of claim 54 wherein the conventional gelling agent comprises a hydratable polymer that comprises one or more functional groups.

57. The subterranean treatment fluid of claim 54 wherein the conventional gelling agent comprises a polysaccharide.

58. The subterranean treatment fluid of claim 57 wherein the polysaccharide comprises one or more of galactose, mannose, glucose, xylose, arabinose, fructose, glucuronic acid, or pyranosyl sulfate.

59. The subterranean treatment fluid of claim 54 wherein the conventional gelling agent comprises a guar gum or a guar gum derivative.

60. The subterranean treatment fluid of claim 54 wherein the conventional gelling agent comprises polyacrylate, polymethacrylate, polyacrylamide, polyvinyl alcohol, or polyvinylpyrrolidone.

61. The subterranean treatment fluid of claim 54 wherein the conventional gelling agent comprises a substantially depolymerized gelling agent.

62. The subterranean treatment fluid of claim 50 wherein the treatment fluid comprises a gelling agent in the range of from about 0.1% to about 5% by weight of the water.

63. The subterranean treatment fluid of claim 50 wherein the amine moiety comprises a hydrazide group, a hydrazine group, diamino compound; a polyethyleneimine; a polyallylamine; a protein; or a peptide.

64. The subterranean treatment fluid of claim 50 further comprising, after the step of allowing at least one crosslink to from between at least one carbonyl moiety and at least one amine moiety, the step of contacting the crosslink with a reducing agent.

65. The subterranean treatment fluid of claim 64 wherein the reducing agent comprises a borohydrides, a cyanoborohydrides, or a combination thereof.

66. The subterranean treatment fluid of claim 50 further comprising particulates.
